(19) United States
(12) Patent Application Publication
(10) Pub. No.: US 2025/0287491 A1
(43) Pub. Date: Sep. 11, 2025

(54) METHODS AND SYSTEMS FOR CONTROLLING VOLTAGES OF X-RAY IMAGING SYSTEMS AND X-RAY IMAGING SYSTEMS, DEVICES, AND STORAGE MEDIUMS

(71) Applicant: SHANGHAI UNITED IMAGING HEALTHCARE CO., LTD., Shanghai (CN)

(72) Inventors: Fan ZHAO, Shanghai (CN); Guoping ZHU, Shanghai (CN); Bin CAO, Shanghai (CN)

(73) Assignee: SHANGHAI UNITED IMAGING HEALTHCARE CO., LTD., Shanghai (CN)

(21) Appl. No.: 19/218,224

(22) Filed: May 24, 2025

Related U.S. Application Data
(63) Continuation of application No. PCT/CN2023/133940, filed on Nov. 24, 2023.

(30) Foreign Application Priority Data
Nov. 24, 2022 (CN) 202211485123.X

(51) Int. Cl. H05G 1/10

(52) U.S. Cl. CPC H05G 1/10

(57) ABSTRACT

Methods and systems for controlling a voltage of an X-ray imaging system and X-ray imaging systems are provided. A method includes: obtaining an initial tube voltage and a target tube voltage; and adjusting an actual tube voltage of the X-ray imaging system by controlling a working state of one or more devices of the X-ray imaging system based on the initial tube voltage and the target tube voltage in an inter-frame period of time. An output voltage of a high voltage generator is changed to the target tube voltage required when the X-ray imaging system starts imaging to obtain the target frame in the inter-frame period of time, so that the actual tube voltage is equal to or close to the target tube voltage when the target frame is loaded.

### CROSS-REFERENCE TO RELATED APPLICATIONS

This a application is a continuation of International Patent Application No. PCT/CN2023/133940, filed on Nov. 24, 2023, which claims the priority to Chinese Patent Application No. 202211485123.X, filed on Nov. 24, 2022, the entire contents of which are incorporated herein by reference.

### TECHNICAL FIELD

The present disclosure relates to the field of X-ray imaging technology, and in particular, to methods and systems for controlling a voltage of an X-ray imaging system and X-ray imaging systems.

### BACKGROUND

In a process of using pulsed fluoroscopy of an X-ray fluoroscopy system, a tube current may be usually controlled to be turned on or turned off using a grid to reduce a soft ray radiation dose suffered by a patient and a medical worker. As shown in FIG. 3, when a grid is in an open state (ON), cathode electrons may be bound to a cathode surface and may not form the tube current, which may be equivalent to a tube without a load. When the grid is in a close state (OFF), the cathode electrons may be accelerated to bombard the anode and form the tube current, which may be equivalent to a working load. Therefore, whether the grid is in the open state or not may determine a load state of a high voltage power supply.

On the other hand, in order to maintain a consistent image brightness during the fluoroscopy, a loading parameter of each frame may be usually adjusted using the Auto Brightness Control (ABS) manner. The loading parameter may be adjusted in real time due to different attenuation capabilities of the rays at different positions and angles of a scanned object.

However, commonly used tube current pulse mode fluoroscopy system simply turns off a power device of a high voltage generator after loading an initial tube voltage of a current frame, and an equivalent load resistor in a circuit discharges freely. The actual tube voltage starts to be adjusted to the target tube voltage only at the beginning of the loading of a target frame. However, the actual tube voltage is not adjusted to the target tube voltage in time and the imaging quality is reduced.

Accordingly, it is desirable to provide methods and systems for controlling a voltage of an X-ray imaging system and X-ray imaging systems, so that the actual tube voltage may be changed to the target tube voltage that is required when the X-ray imaging system starts imaging, thereby obtaining the target frame in an inter-frame period of time and improving the imaging quality.

### SUMMARY

One or more embodiments of the present disclosure provide a method for controlling a voltage of an X-ray imaging system. The method may be implemented by a processor. The method may include: obtaining an initial tube voltage and a target tube voltage; and adjusting an actual tube voltage of the X-ray imaging system by controlling a working state of one or more devices of the X-ray imaging system based on the initial tube voltage and the target tube voltage in an inter-frame period of time.

In some embodiments, the method may further include: making an output of a high voltage generator in a controllable state in the inter-frame period of time.

In some embodiments, the adjusting the actual tube voltage of the X-ray imaging system by controlling the working state of the one or more devices of the X-ray imaging system based on the initial tube voltage and the target tube voltage may include: in response to the target tube voltage being equal to the initial tube voltage, maintaining the actual tube voltage at the initial tube voltage in the inter-frame period of time by adjusting the output of the high voltage generator.

In some embodiments, the adjusting the actual tube voltage of the X-ray imaging system by controlling the working state of the one or more devices of the X-ray imaging system based on the initial tube voltage and the target tube voltage may include: in response to the target tube voltage being not equal to the initial tube voltage, changing the actual tube voltage from the initial tube voltage to the target tube voltage in at least a portion of the inter-frame period of time by adjusting a working state of at least one device of the X-ray imaging system in the inter-frame period of time.

In some embodiments, the adjusting the working state of at least one device of the X-ray imaging system in the inter-frame period of time includes: in response to determining that the target tube voltage is obtained, adjusting the output of the high voltage generator.

In some embodiments, the adjusting the working state of at least one device of the X-ray imaging system in the inter-frame period of time includes: in response to determining that the target tube voltage is obtained, controlling a discharge load to discharge.

In some embodiments, the adjusting the working state of at least one device of the X-ray imaging system in the inter-frame period of time includes: in response to determining that the target tube voltage is obtained, obtaining a natural discharge state by turning off the high voltage generator and switching the natural discharge state to a load discharge state.

In some embodiments, the adjusting the actual tube voltage of the X-ray imaging system by controlling the working state of the one or more devices of the X-ray imaging system based on the initial tube voltage and the target tube voltage may include: in response to the target tube voltage is greater than the initial tube voltage, increasing the actual tube voltage to the target tube voltage in the inter-frame period of time by adjusting the output of the high voltage generator.

In some embodiments, the adjusting the output of the high voltage generator may include: in response to determining that the target tube voltage is obtained, adjusting the output of the high voltage generator.

In some embodiments, an adjustment period of time for adjusting the output of the high voltage generator may be a period of time from a first time point when the target tube voltage is obtained to a second time point when the X-ray imaging system starts imaging to obtain a target frame, and the adjustment period of time may be determined by: determining an estimated adjustment period of time based on a hardware configuration and a difference between the initial tube voltage and the target tube voltage; and determining a start time of the adjustment period of time based on the estimated adjustment period of time.

In some embodiments, the changing the actual tube voltage to the target tube voltage in the inter-frame period of time may include: increasing the actual tube voltage to the target tube voltage before a time point when the X-ray imaging system starts imaging to obtain a target frame.

In some embodiments, the adjusting the actual tube voltage of the X-ray imaging system by controlling the working state of the one or more devices of the X-ray imaging system based on the initial tube voltage and the target tube voltage may include: in response to the target tube voltage is less than the initial tube voltage, decreasing the actual tube voltage to the target tube voltage in the at least the portion of the inter-frame period of time by controlling at least one discharge load in the X-ray imaging system to discharge in the inter-frame period of time.

In some embodiments, the discharge load may include a tube, and the decreasing the actual tube voltage to the target tube voltage in the at least the portion of the inter-frame period of time by controlling the at least one discharge load in the X-ray imaging system to discharge in the inter-frame period of time may include: decreasing the actual tube voltage to the target tube voltage by making the tube discharge by closing a grid of the tube.

In some embodiments, the discharge load may include an internal load of the high voltage generator, and the decreasing the actual tube voltage to the target tube voltage in the at least the portion of the inter-frame period of time by controlling the at least one discharge load in the X-ray imaging system to discharge in the inter-frame period of time may include: decreasing the actual tube voltage to the target tube voltage by controlling the internal load of the high voltage generator to discharge.

In some embodiments, the controlling the at least one discharge load in the X-ray imaging system to discharge may include: in response to determining that the target tube voltage is obtained, controlling the at least one discharge load to discharge.

In some embodiments, the decreasing the actual tube voltage to the target tube voltage in the at least the portion of the inter-frame period of time by controlling the at least one discharge load in the X-ray imaging system to discharge in the inter-frame period of time may include: decreasing the actual tube voltage to the target tube voltage before a time when the X-ray imaging system starts imaging to obtain a target frame.

In some embodiments, the controlling the at least one discharge load in the X-ray imaging system to discharge includes controlling the at least one discharge load to discharge by stages, and the controlling the at least one discharge load to discharge by stages may include: in response to determining that the target tube voltage is obtained, obtaining a natural discharge state by turning off the high voltage generator; and decreasing the actual tube voltage to the target tube voltage by switching the natural discharge state to a load discharge state before a time point when the X-ray imaging system starts imaging to obtain a target frame.

In some embodiments, the decreasing the actual tube voltage to the target tube voltage in the at least the portion of the inter-frame period of time by controlling the at least one discharge load in the X-ray imaging system to discharge in the inter-frame period of time may include: decreasing the actual tube voltage to be less than the target tube voltage before a time point when the X-ray imaging system starts imaging to obtain a target frame.

In some embodiments, the decreasing the actual tube voltage to be less than the target tube voltage may include: decreasing the actual tube voltage to a minimum magnitude of voltage.

In some embodiments, the method may further include: increasing the actual tube voltage to the target tube voltage by adjusting an output of a high voltage generator at the time point when the X-ray imaging system starts imaging to obtain a target frame.

In some embodiments, the method may further include: increasing the actual tube voltage to the target tube voltage by adjusting an output of a high voltage generator before a time point when the X-ray imaging system starts imaging to obtain a target frame.

One or more embodiments of the present disclosure provide a system for controlling a voltage of an X-ray imaging system. The system may include: an obtaining module configured to obtain an initial tube voltage and a target tube voltage; and a control module configured to adjust an actual tube voltage of the X-ray imaging system by controlling a working state of one or more devices of the X-ray imaging system based on initial tube voltage and the target tube voltage in an inter-frame period of time.

One or more embodiments of the present disclosure provide an X-ray imaging system. The imaging system may include a high voltage generator, an X-ray tube, and a processor. An output end of the high voltage generator may be connected to an input end of the X-ray tube, the high voltage generator may be configured to supply power to the X-ray tube, and the processor may be configured to perform the method for controlling the voltage of the X-ray imaging system as described in any of the embodiments.

One or more embodiments of the present disclosure provide an X-ray imaging device. The X-ray imaging device may be configured to perform the method for controlling the voltage of the X-ray imaging system as described in any of the embodiments.

One or more embodiments of the present disclosure provide a non-transitory computer readable storage medium storing computer instructions. When reading the computer instructions in the storage medium, a computer may perform the method for controlling the voltage of the X-ray imaging system as described in any of the embodiments.

### BRIEF DESCRIPTION OF THE DRAWINGS

The present disclosure is further illustrated in terms of exemplary embodiments. These exemplary embodiments are described in detail with reference to the drawings. These embodiments are non-limiting exemplary embodiments, in which the same reference numbers represent the same structures, wherein:

FIG. 1 is a schematic diagram illustrating an exemplary system for controlling a voltage of an X-ray imaging system according to some embodiments of the present disclosure;

FIG. 2 is a block diagram illustrating an exemplary system for controlling a voltage of an X-ray imaging system according to some embodiments of the present disclosure;

FIG. 3 is a signal schematic diagram illustrating a manner for controlling a voltage of an X-ray imaging system when a target tube voltage of a target frame is equal to an initial tube voltage of a current frame in the prior art;

FIG. 4 is a signal schematic diagram illustrating a manner for controlling a voltage of an X-ray imaging system when a target tube voltage of a target frame is greater than an initial tube voltage of a current frame in the prior art;

FIG. 5 is a signal schematic diagram illustrating a manner for controlling a voltage of an X-ray imaging system when a target tube voltage of a target frame is less than an initial tube voltage of a current frame in the prior art;

FIG. 6 is a flowchart illustrating an exemplary process for controlling a voltage of an X-ray imaging according to some embodiments of the present disclosure;

FIG. 7 is a schematic diagram illustrating an output of a high voltage generator being in a controllable state in an inter-frame period of time according to some embodiments of the present disclosure;

FIG. 8 is a signal schematic diagram illustrating a process for controlling a voltage of an X-ray imaging system when a target tube voltage is equal to an initial tube voltage according to some embodiments of the present disclosure;

FIG. 9 is a signal schematic diagram illustrating a process for controlling a voltage of an X-ray imaging system when a target tube voltage is greater than an initial tube voltage according to some embodiments of the present disclosure;

FIG. 10 is a signal schematic diagram illustrating discharging through a tube when a target tube voltage is less than an initial tube voltage according to some embodiments of the present disclosure;

FIG. 11 is a signal schematic diagram illustrating discharging through an internal load of a high voltage generator when a target tube voltage is less than an initial tube voltage according to some embodiments of the present disclosure;

FIG. 12 is a signal schematic diagram illustrating a process for controlling a voltage of an X-ray imaging system when a target tube voltage is less than an initial tube voltage according to some embodiments of the present disclosure; and

FIG. 13 is a signal schematic diagram illustrating another process for controlling a voltage of an X-ray imaging system when a target tube voltage is less than an initial tube voltage according to some embodiments of the present disclosure.

### DETAILED DESCRIPTION

In order to more clearly illustrate the technical solutions related to the embodiments of the present disclosure, a brief introduction of the drawings referred to the description of the embodiments is provided below. Obviously, drawings described below are only some examples or embodiments of the present disclosure. Those skilled in the art, without further creative efforts, may apply the present disclosure to other similar scenarios according to these drawings. Unless obviously obtained from the context or the context illustrates otherwise, the same numeral in the drawings refers to the same structure or operation.

It should be understood that the “system,” “device,” “unit,” and/or “module”

used herein are one method to distinguish different components, elements, parts, sections, or assemblies of different levels. However, if other words can achieve the same purpose, the words can be replaced by other expressions.

As used in the disclosure and the appended claims, the singular forms “a,” “an,” and “the” include plural referents unless the content clearly dictates otherwise; the plural forms may be intended to include singular forms as well. In general, the terms “comprise,” “comprises,” and/or “comprising,” “include,” “includes,” and/or “including,” merely prompt to include steps and elements that have been clearly identified, and these steps and elements do not constitute an exclusive listing. The methods or devices may also include other steps or elements.

The flowcharts used in the present disclosure illustrate operations that the system implements according to the embodiment of the present disclosure. It should be understood that the foregoing or following operations may not necessarily be performed exactly in order. Instead, the operations may be processed in reverse order or simultaneously. Besides, one or more other operations may be added to these processes, or one or more operations may be removed from these processes.

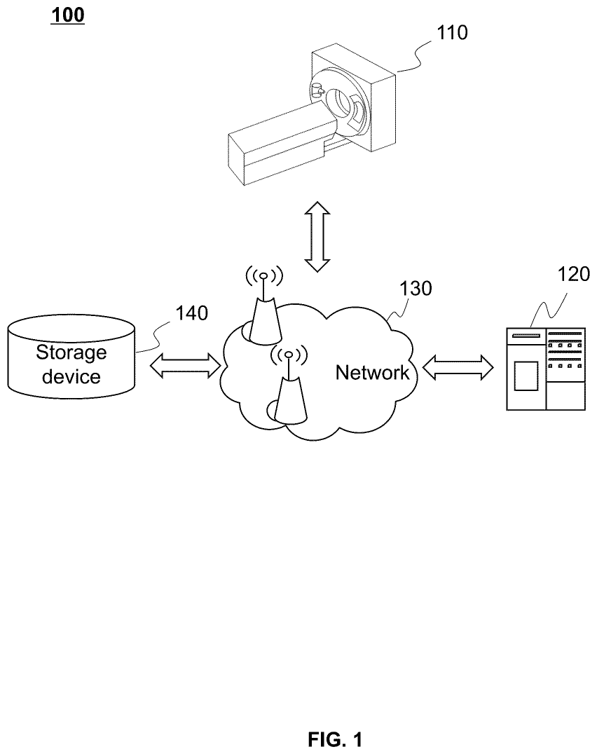

FIG. 1 is a schematic diagram illustrating an exemplary system for controlling a voltage of an X-ray imaging system according to some embodiments of the present disclosure. As shown in FIG. 1, the system 100 for controlling the voltage of the X-ray imaging system may include an X-ray imaging device 110, a processor 120, a network 130, and a storage device 140.

The X-ray imaging device 110 may be configured to scan a patient and generate a scan image. In some embodiments, the X-ray imaging device 110 may include a high voltage generator and an X-ray tube. An output end of the high voltage generator may be connected to an input end of the X-ray tube, and the high voltage generator may be configured to supply power to the X-ray tube. In some embodiments, the processor 120 and the storage device 140 may be a portion of the X-ray imaging device 110.

The processor 120 may be configured to process data and/or information obtained from the X-ray imaging device 110 and/or the storage device 140. For example, the processor 120 may obtain an initial tube voltage and a target tube voltage. As another example, the processor 120 may obtain a comparison result by comparing the target tube voltage with the initial tube voltage. As yet another example, the processor 120 may adjust an actual tube voltage of the X-ray imaging system by controlling a working state of one or more devices of the X-ray imaging system based on the comparison result in an inter-frame period of time.

In some embodiments, the processor 120 may be a single server or a server group. The server group may be centralized or distributed. In some embodiments, the processor 120 may be local or remote. In some embodiments, the processor 120 may be connected to the X-ray imaging device 110 and/or the storage device 140 via the network 130 or directly connected to the X-ray imaging device 110 and/or the storage device 140 to access information and/or data stored thereon. In some embodiments, the processor 120 may be integrated in the X-ray imaging device 110. In some embodiments, the processor 120 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

The network 130 may include any suitable network that may facilitate exchange of information and/or data of the system for controlling the voltage of the X-ray imaging system. In some embodiments, one or more components (e.g., the X-ray imaging device 110, the processor 120, or the storage device 140) of the system for controlling the voltage of the X-ray imaging system may be connected to and/or in communication with other components of the system for controlling the voltage of the X-ray imaging system via the network 130. For example, the processor 120 may obtain an initial tube voltage from the storage device 140 via the network 130.

In some embodiments, the network 130 may include a wired network, a wireless network, or any combination thereof. For example, the network 130 may include a cable network, an optical network, a telecommunication network, the Internet, a local area network (LAN), a wide area network (WAN), a wireless local area network (WLAN), a metropolitan area network (MAN), a public switched telephone network (PSTN), a Bluetooth network, a ZigBee network (ZigBee), a near-field communication (NFC), an in-device bus, an in-device line, a cable connection, or the like, or any combination thereof. The network connection between the components may be in one or more of the ways. In some embodiments, the network 130 may include a point-to-point topology, a shared topology, a center-based topology, or the like, or any combination thereof. In some embodiments, the network 130 may include one or more network access points. For example, the network 130 may include wired and/or wireless network access points, such as base stations and/or Internet access points, through which one or more components of the system for controlling the voltage of the X-ray imaging system may be connected to the network 130 to exchange data and/or information.

The storage device 140 may store data, instructions, and/or any other information. In some embodiments, the storage device 140 may store data obtained from the X-ray imaging device 110 and/or the processor 120. In some embodiments, the storage device 140 may store data and/or instructions that the processor 120 may execute or use to perform exemplary methods described in the present disclosure.

In some embodiments, the storage device 140 may include a mass storage, a removable storage, a volatile read-write memory, a read-only memory (ROM), or the like, or any combination thereof. In some embodiments, the storage device 140 may be implemented on a cloud platform.

In some embodiments, the storage device 140 may be connected to the network 130 to communicate with one or more components (e.g., the X-ray imaging device 110, the processor 120) of the system 100 for controlling the voltage of the X-ray imaging system. One or more components of the system 100 for controlling the voltage of the X-ray imaging system may access data or instructions stored in the storage device 140 via the network 130. In some embodiments, the storage device 140 may be a portion of the processor 120.

It should be noted that the system 100 for controlling the voltage of the X-ray imaging system is merely provided for the purpose of illustration and is not intended to limit the scope of the present disclosure. For those skilled in the art, various modifications or changes may be made based on the descriptions of the present disclosure. For example, the system 100 for controlling the voltage of the X-ray imaging system may also include a database, an information source, etc. As another example, the system 100 for controlling the voltage of the X-ray imaging system may be implemented on other devices to achieve similar or different functions. However, changes and modifications do not depart from the scope of the present disclosure.

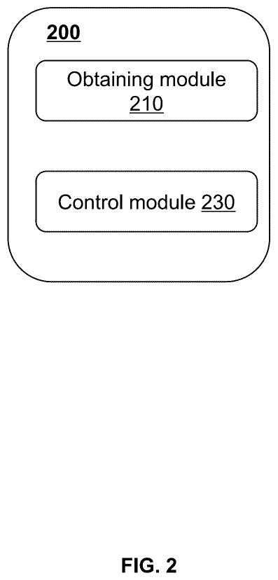

FIG. 2 is a block diagram illustrating an exemplary system for controlling a voltage of an X-ray imaging system according to some embodiments of the present disclosure. In some embodiments, the system 200 for controlling the voltage of the X-ray imaging may include an obtaining module 210, and a control module 230. In some embodiments, the system 100 illustrated in FIG. 1 may be implemented by the system 200 illustrated in FIG. 2.

The obtaining module 210 may be configured to obtain an initial tube voltage and a target tube voltage.

The control module 230 may be configured to adjust an actual tube voltage of the X-ray imaging system by controlling a working state of one or more devices of the X-ray imaging system based on the initial tube voltage and the target tube voltage in an inter-frame period of time.

In some embodiments, the control module 230 may be further configured to make an output of a high voltage generator in a controllable state in the inter-frame period of time.

In some embodiments, the control module 230 may be further configured to, in response to the target tube voltage being equal to the initial tube voltage, maintain the actual tube voltage at the initial tube voltage in the inter-frame period of time by adjusting the output of the high voltage generator.

In some embodiments, the control module 230 may be further configured to, in response to the target tube voltage being not equal to the initial tube voltage, change the actual tube voltage from the initial tube voltage to the target tube voltage in at least a portion of the inter-frame period of time by adjusting a working state of at least one device of the X-ray imaging system in the inter-frame period of time.

In some embodiments, the control module 230 may be further configured to, in response to determining that the target tube voltage is obtained, adjust the output of the high voltage generator.

In some embodiments, the control module 230 may be further configured to, in response to determining that the target tube voltage is obtained, control a discharge load to discharge.

In some embodiments, the control module 230 may be further configured to, in response to determining that the target tube voltage is obtained, obtain a natural discharge state by turning off the high voltage generator and switching the natural discharge state to a load discharge state.

In some embodiments, the control module 230 may be further configured to, in response to the target tube voltage is greater than the initial tube voltage, increase the actual tube voltage to the target tube voltage in the inter-frame period of time by adjusting the output of the high voltage generator.

In some embodiments, the control module 230 may be further configured to in response to determining that the target tube voltage is obtained, adjust the output of the high voltage generator.

In some embodiments, the control module 230 may be further configured to determine an estimated adjustment period of time based on a hardware configuration and a difference between the initial tube voltage and the target tube voltage, and determine a start moment of the adjustment period of time based on the estimated adjustment period of time.

In some embodiments, the control module 230 may be further configured to increase the actual tube voltage to the target tube voltage before a time point when the X-ray imaging system starts imaging to obtain a target frame.

In some embodiments, the control module 230 may be further configured to, in response to the target tube voltage is less than the initial tube voltage, decrease the actual tube voltage to the target tube voltage in the at least the portion of the inter-frame period of time by controlling at least one discharge load in the X-ray imaging system to discharge in the inter-frame period of time.

In some embodiments, the control module 230 may be further configured to decrease the actual tube voltage to the target tube voltage by making a tube discharge by closing a grid of the tube.

In some embodiments, the control module 230 may be further configured to decrease the actual tube voltage to the target tube voltage by controlling an internal load of the high voltage generator to discharge.

In some embodiments, the control module 230 may be further configured to in response to determining that the target tube voltage is obtained, control the at least one discharge load to discharge.

In some embodiments, the control module 230 may be further configured to decrease the actual tube voltage to the target tube voltage before a time point when the X-ray imaging system starts imaging to obtain the target frame.

In some embodiments, the control module 230 may be further configured to, in response to determining that the target tube voltage is obtained, obtain a natural discharge state by turning off the high voltage generator, and decrease the actual tube voltage to the target tube voltage by switching the natural discharge state to a load discharge state before the time point when the X-ray imaging system starts imaging to obtain the target frame.

In some embodiments, the control module 230 may be further configured to decrease the actual tube voltage to be less than the target tube voltage before the time point when the X-ray imaging system starts imaging to obtain the target frame.

In some embodiments, the control module 230 may be further configured to decrease the actual tube voltage to a minimum magnitude of voltage.

In some embodiments, the control module 230 may be further configured to increase the actual tube voltage to the target tube voltage by adjusting the output of the high voltage generator at the time point when the X-ray imaging system starts imaging to obtain the target frame.

In some embodiments, the control module 230 may be further configured to increase the actual tube voltage to the target tube voltage by adjusting the output of the high voltage generator before the time point when the X-ray imaging system starts imaging to obtain the target frame.

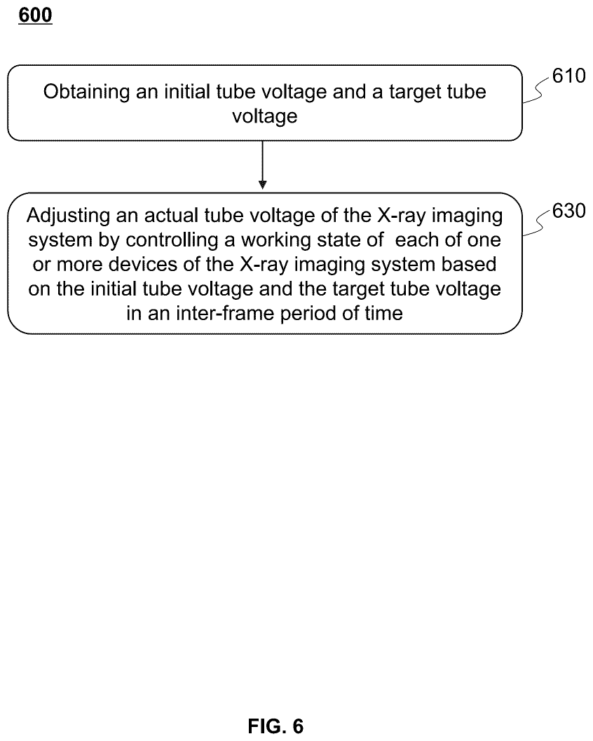

More descriptions regarding the obtaining module 210, and the control module 230 may be found in FIG. 6 and related descriptions thereof.

It should be noted that the above description of the system 200 for controlling the voltage of the X-ray imaging system and modules thereof is merely provided for convenience of illustration and is not intended to limit the present disclosure within the scope of the illustrated embodiments. It is understood that for those skilled in the art, after understanding the principle of the system, it may be possible to arbitrarily combine various modules to form a sub-system to connect with other modules without departing from the principle. In some embodiments, the obtaining module 210, and the control module 230 disclosed in FIG. 2 may be different modules in one system, or one module that implements the functions of two or more of the modules. For example, each module may share one storage module, or each module may have its own storage module. Such deformations are within the scope of protection of the present disclosure.

It should be understood that for an initial tube voltage of a current frame and a target tube voltage of the target frame, the two tube voltages corresponding to the two adjacent image frames may be equal, increased, or decreased, and the process for controlling the voltage of the X-ray imaging system in the three cases is usually as follows.

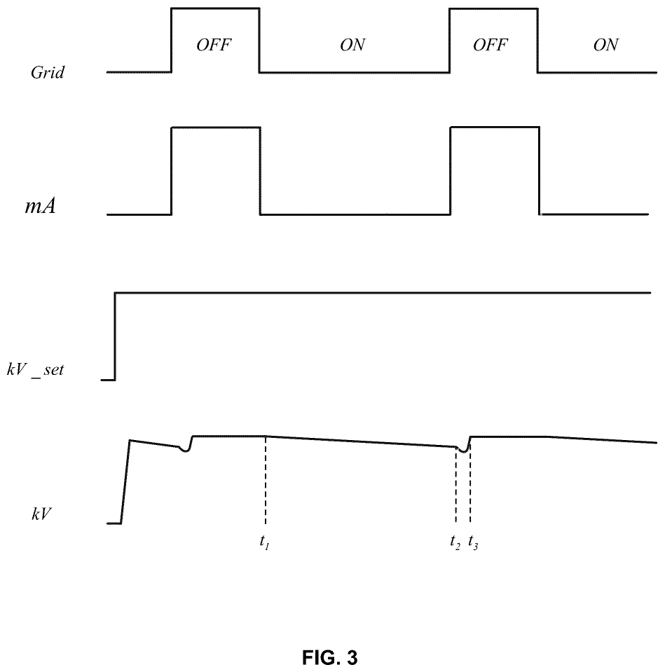

A first case is that the target tube voltage of the target frame is equal to the initial tube voltage of the current frame. As shown in FIG. 3, the high voltage generator completes loading of the initial tube voltage kV_set of the current frame (the initial tube voltage kV_set of the current frame refers to a tube voltage required when the X-ray imaging system images to obtain the current frame) at a time point t₁ and opens a grid by switching the voltage of the grid at the time point t₁, thereby turning off a tube current (mA). At the same time, a power device of the high voltage generator is turned off, an output voltage of the high voltage generator continues to decrease; at a time point t₂, the grid is closed to start the loading of the target tube voltage kV_set of the target frame (the target tube voltage kV_set of the target frame refers to a tube voltage required when the X-ray imaging system images to obtain the target frame). At this time, the output voltage of the high voltage generator is less than the target tube voltage kV_set of the target frame, and it is necessary to compensate the energy lost during the opening of the grid; and the output voltage of the high voltage generator is not adjusted to the target tube voltage kV_set of the target frame until a time point t₃. If cable resistance is not taken into account, the output voltage of the high voltage generator may be considered equal to a voltage across the X-ray tube, so that the actual tube voltage kV may be adjusted to the target tube voltage kV_set of the target frame at the time point t₃.

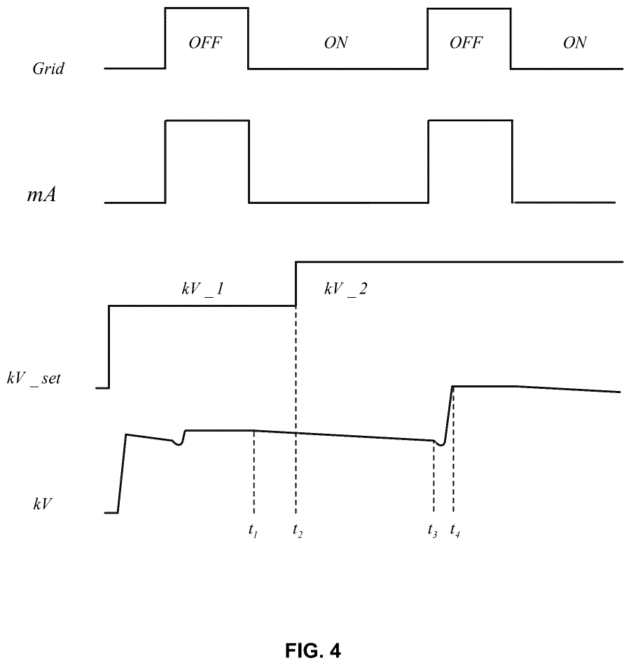

A second case is that the target tube voltage of the target frame is greater than the initial tube voltage of the current frame. As shown in FIG. 4, the high voltage generator completes the loading of the initial tube voltage kV_1 of the current frame (the initial tube voltage kV_1 of the current frame refers to a tube voltage required when the X-ray imaging system images to obtain the current frame) at the time point t₁ and opens the grid at the time point t₁, thereby turning off the tube current (mA). At the same time, the power device of the high voltage generator is turned off, and the output voltage of the high voltage generator continues to decrease and the actual tube voltage kV continues to decrease; at the time point t₂, according to an auto brightness control (ABS) algorithm, it is calculated that the target tube voltage kV_2 (the target tube voltage kV_2 of the target frame refers to a tube voltage required when the X-ray imaging system images to obtain the target frame) of the target frame is greater than the initial tube voltage kV_1 of the current frame; and the high voltage generator closes the grid at the time point t₃ to start the loading of the target tube voltage kV_2 of the target frame, and at this time, it is necessary to continuously compensate the energy to increase the output voltage of the high voltage generator until the output voltage of the high voltage generator is adjusted to the target tube voltage kV_2 of the target frame at a time point t₄, which in turn makes the actual tube voltage kV adjusted to the target tube voltage kV_2 of the target frame.

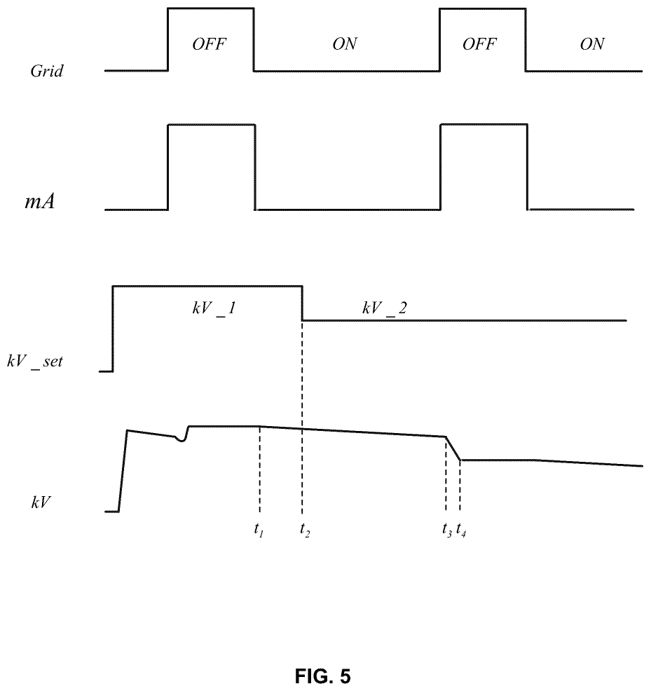

A third case is that the target tube voltage of the target frame is less than the initial tube voltage of the current frame. As shown in FIG. 5, the high voltage generator opens the grid at the time point t₁ to turn off the tube current (mA), and at the same time, turns off the power device of the high voltage generator. At this time, the output voltage of the high voltage generator and the actual tube voltage kV continue to decrease; at the time point t₂, it is calculated that the target voltage kV_2 of the target frame is less than the initial tube voltage kV_1 of the current frame voltage; and at the time point t₃, the grid is closed to start the loading the target tube voltage kV_2 of the target frame, and at this time, the actual tube voltage still needs continue to decrease until the output voltage of the high voltage generator is adjusted to the target tube voltage kV_2 of the target frame at the time point t₄, which in turn makes the actual tube voltage kV adjusted to the target tube voltage kV_2 of the target frame.

At present, in the process for controlling the voltage of the X-ray imaging system in the above three cases, the high voltage generator simply turns off the power device of the high voltage generator after loading the initial tube voltage of the current frame, an equivalent load resistor in the circuit discharges freely, and the output voltage of the high voltage generator starts to be adjusted only at the beginning of the loading of the target frame to make the actual tube voltage adjusted to the target tube voltage, which results in that the actual tube voltage is not able to be adjusted to the target tube voltage in time, the imaging time is prolonged, the radiation measurement suffered by the patient is increased, and the imaging quality is reduced.

FIG. 6 is a flowchart illustrating an exemplary process for controlling a voltage of an X-ray imaging system according to some embodiments of the present disclosure. In some embodiments, the process 600 may be performed by the processor 120 or the system 200 for controlling the voltage of the X-ray imaging system. For example, the process 600 may be stored in a storage device in the form of a program or instruction, and the process 600 may be implemented when the processor 120 or the system 200 for controlling the voltage of the X-ray imaging system executes the instruction. The operations of the illustrated process 600 presented below are intended to be illustrative. In some embodiments, the process 600 may be accomplished with one or more additional operations not described and/or with one or more operations not discussed. In addition, the order in which the operations of the process 600 as illustrated in FIG. 6 and described below is not intended to be limiting.

In 610, an initial tube voltage and a target tube voltage may be obtained.

The initial tube voltage refers to a tube voltage required when the X-ray imaging system images an object to obtain a current frame. The current frame refers to a most recent imaging frame that an X-ray imaging device has completed.

In some embodiments, the processor 120 may obtain the initial tube voltage by accessing the storage device.

The target tube voltage refers to a tube voltage required when the X-ray imaging system images the object to obtain a next frame (subsequently also referred to as a target frame) of the current frame.

In some embodiments, the target tube voltage may be obtained in an inter-frame period of time. In some embodiments, before the X-ray imaging system images the object to obtain the target frame, the processor 120 may determine the target tube voltage by calculating through a preset algorithm. The preset algorithm may include, but is not limited to, an Auto Brightness Control (ABS) algorithm, etc. In other embodiments, the target tube voltage may also be obtained in advance. For example, the processor may obtain the target tube voltage in the entire inter-frame period of time before imaging.

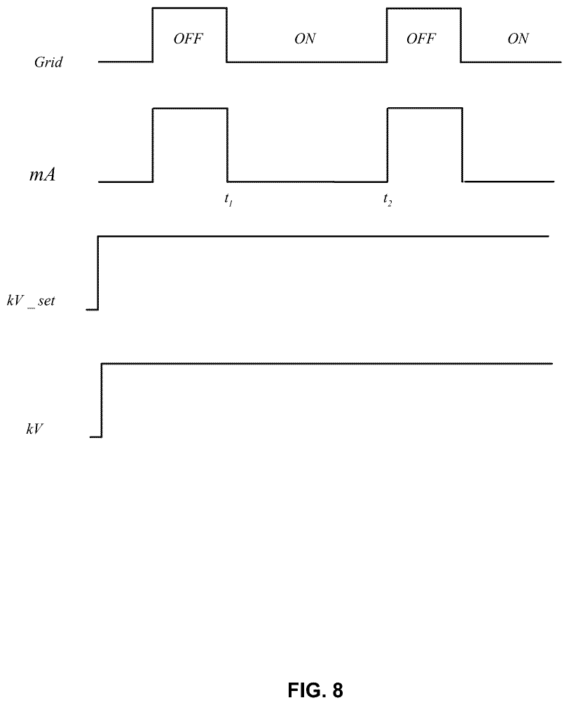

In some embodiments, a value of the tube voltage required for imaging may be indicated by kV_set. Merely by way of example, as shown in FIG. 8, when the tube voltages required for imaging are the same at time points t₁ and t₂, the kV_set at the time point t₁ and the kV_set at the time point t₂ may be the same. In some embodiments, when the tube voltage required for imaging is set according to the value kV_set, the value kV_set may be either a value equal to the tube voltage required for imaging or a setting value proportional to an output value of the tube voltage required for imaging. For example, when kV_set is the setting value proportional to the output value of the tube voltage required for imaging, and if kV_set is set to be 1 and a correspondence between the setting value and the tube voltage required for imaging is 1:1000, the tube voltage required for imaging may be 1 kV based on the setting value kV_set of 1. In the following embodiment parameters, a case in which the value kV_set is equal to the tube voltage required for imaging is described as an example.

In 630, an actual tube voltage of the X-ray imaging system may be adjusted by controlling a working state of each of one or more devices of the X-ray imaging system based on the initial tube voltage and the target tube voltage in the inter-frame period of time.

In some embodiments, the processor may obtain a comparison result by comparing the target tube voltage with the initial tube voltage. For example, the comparison result may include the target tube voltage being equal to, greater than, or less than the initial tube voltage.

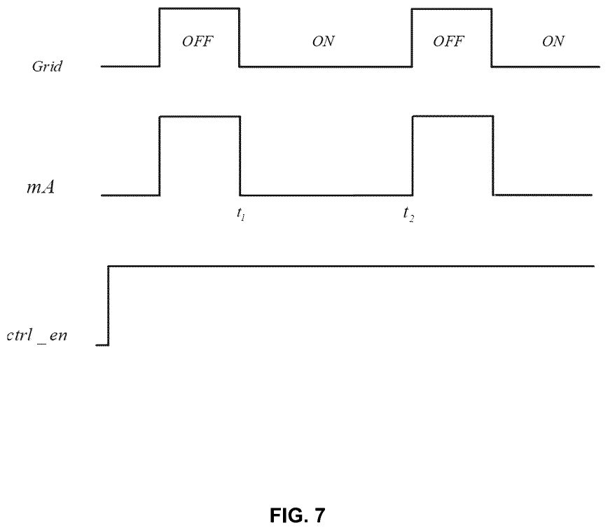

The inter-frame period of time refers a period of time between a time point when the X-ray imaging system stops imaging to obtain the current frame and the time point when the X-ray imaging system starts imaging the object to obtain the target frame. For example, as shown in FIG. 7, the inter-frame period of time may be a period of time from t₁ to t₂.

The one or more devices refers to a component of the X-ray imaging system. In some embodiments, the one or more devices may include a high voltage generator, an X-ray tube, etc.

The working state of each of the one or more devices refers to a state related to turning on the device, turning off of the device, an input power of the device, an output power of the device, etc. For example, a working state of the high voltage generator may include the high voltage generator being turned on or the high voltage generator being turned off. In some embodiments, if the one or more devices include the high voltage generator, the working state of the high voltage generator may include a magnitude of an output voltage of the high voltage generator.

The actual tube voltage refers to a voltage across the X-ray tube.

An output end of a high voltage generator may be connected to an input end of the X-ray tube, and the high voltage generator may be configured to supply power to the X-ray tube. In some embodiments, the processor 120 may adjust the actual tube voltage of the X-ray imaging system by adjusting the output voltage of the high voltage generator. The high voltage generator may include a power device, and the processor 120 may make the output voltage of the high voltage generator constant, increased, or decreased by adjusting the power device. In some embodiments, the high voltage generator may adjust the output voltage of the high voltage generator by adjusting a voltage setting value (the voltage setting value may also be referred to as a voltage loading parameter). The voltage setting value may be set to equal to a magnitude of an actual output voltage of the high voltage generator, or may be set to a value proportional to the actual output voltage of the high voltage generator.

In some embodiments, the processor 120 may maintain the actual tube voltage at the initial tube voltage by adjusting the output of the high voltage generator before the target tube voltage is obtained in the inter-frame period of time. Merely by way of example, as shown in FIG. 7, the high voltage generator may complete loading of the initial tube voltage of the current frame at the time point t₁ and open the grid at the time point t₁ by switching a voltage of the grid, thereby turning off a tube current (mA). If the power device of the high voltage generator is turned off at the same time, the output voltage of the high voltage generator may continue to decrease, thereby resulting in a decrease in the actual tube voltage. In order to maintain the actual tube voltage at the initial tube voltage, the high voltage generator may compensate for consumption of an equivalent load impedance in a current circuit by continuously outputting voltage through the power device to keep the output voltage of the high voltage generator constant, which may in turn keep the actual tube voltage constant. Ctrl_en in FIG. 7 refers to a controller signal of the high voltage generator. The controller signal Ctrl_en of the high voltage generator refers to a signal for controlling the actual output voltage of the high voltage generator. The controller signal Ctrl_en of the high voltage generator may be always maintained active, which may indicate that the high voltage generator is in an adjustable state.

In some embodiments, the actual tube voltage maintained at the initial tube voltage refers to a range set based on the initial tube voltage, and the actual tube voltage may be equal to the initial tube voltage or close to the initial tube voltage. For example, if the initial tube voltage is M, the actual tube voltage may be (0.9M, 1.1M).

In some embodiments of the present disclosure, the actual tube voltage may be maintained at the initial tube voltage by adjusting the output of the high voltage generator. If a subsequent comparison result is that the target tube voltage is equal to the initial tube voltage, the actual tube voltage may be quickly adjusted to the target tube voltage, which may facilitate imaging. It is noted that in other embodiments, before the target tube voltage is obtained in the inter-frame period of time, the processor 120 may also turn off the power device of the high voltage generator, an equivalent load resistor in the circuit may discharge freely, and the subsequent control process may be executed after the target tube voltage is obtained.

In some embodiments, in response to determining that the comparison result is that the target tube voltage is equal to the initial tube voltage, the processor 120 may maintain the actual tube voltage at the initial tube voltage in the inter-frame period of time by adjusting the output of the high voltage generator.

Merely by way of example, as shown in FIG. 8, the target tube voltage kV_set of the target frame may be equal to the initial tube voltage kV_set of the current frame. The high voltage generator may complete the loading of the initial tube voltage kV_set of the current frame at the time point t₁ and open the grid at the time point t₁ by switching the voltage of the grid, thereby turning off the tube current (mA). At this time, the high voltage generator may compensate for consumption of the equivalent load impedance in the current circuit by continuously outputting voltage through the power device to keep the output voltage of the high voltage generator constant, which may in turn keep the actual tube voltage kV constant. For example, the actual tube voltage kV may be expressed as a horizontal straight line. At the time point t₂, when the X-ray imaging system may start imaging to obtain the target frame (which may mean the X-ray imaging system may start loading the target frame), the voltage supplied by the high voltage generator to the X-ray tube may be equal to or close to the target tube voltage kV_set of the target frame, and the X-ray tube may be able to work with the target tube voltage kV_set of the target frame at this time.

In some embodiments, in response to determining that the comparison result is that the target tube voltage that is not equal to the initial tube voltage, during the inter-frame period of time, the processor 120 may change the actual tube voltage from the initial tube voltage to the target tube voltage in at least a portion of the inter-frame period of time by adjusting a working state of at least one device of the X-ray imaging system in the inter-frame period of time, so that at the time point when the X-ray imaging system starts imaging to obtain the target frame, the actual tube voltage may be equal to or close to the target tube voltage, which may make the X-ray tube capable of starting working with a tube voltage equal to or close to the target tube voltage at the time point when the X-ray imaging system starts imaging to obtain the target frame.

Merely by way of example, in response to determining that the comparison result is that the target tube voltage is greater than the initial tube voltage, the processor 120 may increase the actual tube voltage from the initial tube voltage by increasing the output voltage of the high voltage generator in the at least a portion of the inter-frame period of time, so that the actual tube voltage may be gradually equal to or close to the target tube voltage. In response to determining that the comparison result is that the target tube voltage is less than the initial tube voltage, the processor 120 may decrease the actual tube voltage from the initial tube voltage by reducing the output voltage of the high voltage generator or increasing a load in the circuit in the at least a portion of the inter-frame period of time, so that the actual tube voltage may be gradually equal to or close to the target tube voltage.

In some embodiments, in the inter-frame period of time, the processor may adjust, in response to determining that the target tube voltage is obtained, the output of the high voltage generator to change to change a magnitude of the actual tube voltage. In some embodiments, in the inter-frame period of time, the processor may control, in response to determining that the target tube voltage is obtained, a discharge load to discharge to change the magnitude of the actual tube voltage. In some embodiments, in the inter-frame period of time, the processor may obtain, in response to determining that the target tube voltage is obtained, a natural discharge state by turning off the high voltage generator and switch the natural discharge state to a load discharge state to change the magnitude of the actual tube voltage.

In some embodiments of the present disclosure, when the target tube voltage is not equal to the initial tube voltage, the actual tube voltage may be increased from the initial tube voltage to the target tube voltage by adjusting the working state of the device, so that the actual tube voltage may be equal to or close to the target tube voltage before the X-ray imaging system starts imaging to obtain the target frame, which is conducive to fast imaging and improving imaging quality.

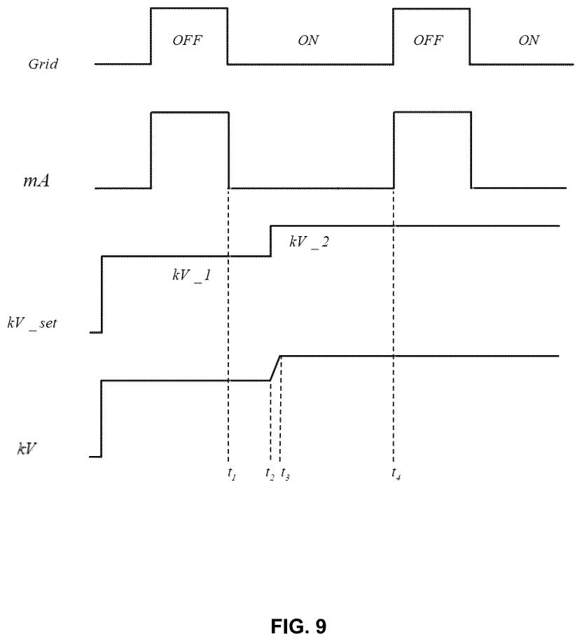

In some embodiments, in response to determining that the comparison result is that the target tube voltage is greater than the initial tube voltage, the processor 120 may increase the actual tube voltage to the target tube voltage in the inter-frame period of time by adjusting the output of the high voltage generator. Merely by way of example, as shown in FIG. 9, the high voltage generator may complete the loading of the initial tube voltage of the current frame at the time point t₁ and open the grid at this time by switching the voltage of the grid, thereby turning off the tube current (mA). In the period of time of t₁ to t₂, the high voltage generator may maintain the initial tube voltage kV_1 of the current frame by continuously outputting voltage through the power device. It may be calculated that the target tube voltage of the target frame is increased to kV_2 at the time point t₂, at this time, the high voltage generator may continue to control the power device to be in an output state, and the high voltage generator may adjust the output voltage to be equal to the target tube voltage kV_2 of the target frame at the moment of t₃, so that the actual tube voltage of the X-ray tube may be equal to the target tube voltage kV_2 of the target frame. The X-ray tube may be able to work with the target tube voltage kV_2 of the target frame at a time point t₄ when the X-ray imaging system starts imaging to obtain the target frame. In some embodiments, due to the limitation of an output power of the high voltage generator, at the time point t₄, the high voltage generator may also make the actual tube voltage of the X-ray tube close to the target tube voltage kV_2 of the target frame by adjusting the output voltage to be close to the target tube voltage kV_2 of the target frame. At the time point when the X-ray imaging system starts imaging to obtain the target frame, the high voltage generator may increase the actual tube voltage to the target tube voltage by continuing to adjust the output of the high voltage generator.

In some embodiments of the present disclosure, when the target tube voltage is greater than the initial tube voltage, the output voltage of the high voltage generator may be increased, so that the actual tube voltage may be adjusted to the target tube voltage before the time point when the X-ray imaging system starts imaging to obtain the target frame, thereby shortening the imaging time, reducing the radiation measurement, and improving the imaging quality.

In some embodiments, in the inter-frame period of time, the processor may, in response to determining that the target tube voltage is obtained, adjust an output of a high voltage generator. For example, if the target tube voltage is obtained in the inter-frame period of time, the processor 120 may adjust the output of the high voltage generator from a time point when the target tube voltage is obtained. Merely by way of example, as shown in FIG. 9, when the target tube voltage is greater than the initial tube voltage, if the processor 120 may determine that the target tube voltage is kV_2 by calculating through an ABS algorithm at the time point t2, the processor 120 may increase the actual tube voltage from the initial tube voltage to the target tube voltage by starting to control the high voltage generator to increase the output voltage at the time point t2. As another example, if the target tube voltage is obtained in advance, the processor may adjust the output of the high voltage generator immediately at the beginning of the inter-frame period of time.

In some embodiments of the present disclosure, the output of the high voltage generator may be adjusted from the time point when the target tube voltage is obtained, so that the high voltage generator may have a relatively long period of time to adjust the actual tube voltage to the target tube voltage as close as possible to the target frame before the time point when the X-ray imaging system starts imaging to obtain the target frame.

In some embodiments, an adjustment period of time that the processor 120 adjusts the output of the high voltage generator may be a period of time from a first time point when the target tube voltage is obtained to a second time point when the X-ray imaging system starts imaging to obtain the target frame. The adjustment period of time refers to a period of time used to adjust the output of the high voltage generator. For example, as shown in FIG. 9, the processor 120 may obtain the target tube voltage at the time point t2, and the X-ray imaging system starts imaging to obtain the target frame at the time point t4. The processor 120 may adjust the output of the high voltage generator in the period of time of t2 to t4.

In some embodiments, the processor 120 may determine an estimated adjustment period of time based on a hardware configuration and a difference between the initial tube voltage and the target tube voltage, and determine a start time of the adjustment period of time based on the estimated adjustment period of time.

The hardware configuration refers to a configuration parameter related to a power of the device of the X-ray imaging system. For example, the hardware configuration may include a maximum output power of the high voltage generator, a rated output power, etc.

In some embodiments, the processor 120 may determine the estimated adjustment period of time based on the hardware configuration and a difference between the initial tube voltage and the target tube voltage through a preset data comparison table. The preset data comparison table may record estimated adjustment periods of time corresponding to different hardware configurations and the difference between the initial tube voltage and the target tube voltage. The preset data comparison table may be preset based on prior knowledge or historical data.

In some embodiments, the processor 120 may determine a time point that is spaced apart from the estimated adjustment period of time before the time point when the X-ray imaging system starts imaging to obtain the target frame as the start time of the adjustment period of time. For example, if the time point when the X-ray imaging system starts imaging to obtain the target frame is t4 and the estimated adjustment period of time is T, the start time of the adjustment period of time may be ta. The time point ta may be before the time point t4, and a period of time between the time point ta and the time point t4 may be T.

In some embodiments of the present disclosure, the start time of the adjustment period of time may be determined based on the estimated adjustment period of time, which may reduce the period of time during which the high voltage generator outputs a higher voltage and reduce energy loss.

In some embodiments, the processor 120 may increase the actual tube voltage to the target tube voltage before the time point when the X-ray imaging system starts imaging to obtain the target frame. Merely by way of example, as shown in FIG. 9, the time point when the X-ray imaging system starts imaging to obtain the target frame may be t4, and the processor 120 may control the high voltage generator to increase the actual tube voltage KV to the target tube voltage kV_2 at the time point t3 (i.e., before the time point t4).

In some embodiments of the present disclosure, the actual tube voltage may be increased to the target tube voltage before the time point when the X-ray imaging system starts imaging to obtain the target frame, so that the X-ray tube may work with the target tube voltage of the target frame at time point when the X-ray imaging system starts imaging to obtain the target frame, thereby shortening the imaging time and decreasing the radiation measurement suffered by the patient.

In some embodiments, in response to determining that the comparison result is that the target tube voltage is less than the initial tube voltage, the processor 120 may decrease the actual tube voltage to the target tube voltage in the at least the portion of the inter-frame period of time by controlling at least one discharge load in the X-ray imaging system to discharge in the inter-frame period of time.

A discharge load refers to a device configured to consume voltage. For example, the discharge load may include a tube, an internal load of the high voltage generator, etc.

In some embodiments of the present disclosure, the actual tube voltage may be equal to or close to the target tube voltage by controlling the discharge load to discharge, so that the actual tube voltage may quickly reach the target tube voltage at the time point when the X-ray imaging system starts imaging to obtain the target frame, thereby shortening the imaging time and reducing the radiation measurement suffered by the patient.

In some embodiments, the one or more devices may include the grid. The working state of the grid may include an open state of the gird, a closing state of the grid, etc.

In some embodiments, when the discharge load includes a tube, the processor 120 may decrease the actual tube voltage to the target tube voltage by making the tube discharge by closing the grid of the tube.

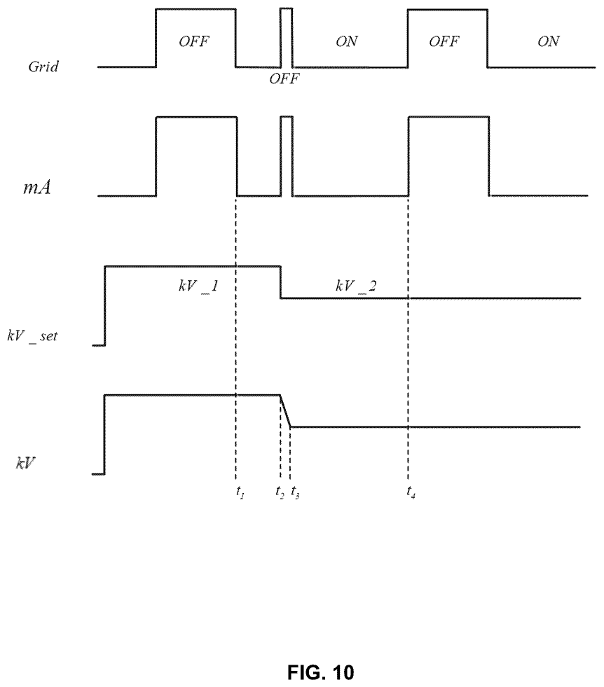

It should be understood that when the grid is in an open state (ON), cathode electrons may be bound to a cathode surface and may not form the tube current (mA), which may be equivalent to a tube without a load. When the grid is in a close state (OFF), the cathode electrons may be accelerated to bombard the anode and form the tube current, which may be equivalent to a tube with the load. Therefore, whether the grid is in the open state or not may determine a load state of the high voltage generator. Merely by way of example, as shown in FIG. 10, the high voltage generator may complete the loading of the initial tube voltage of the current frame at the time point t₁ and open the grid at this time by switching the voltage of the grid, thereby turning off the tube current (mA). In the period of time of t₁ to t₂, the high voltage generator may maintain the initial tube voltage kV_1 of the current frame by continuously outputting voltage through the power device. The processor 120 may determine that the target tube voltage of the target frame decreases to kV_2 at the time point t₂, and the high voltage generator may briefly close the grid to discharge in the period of time of t₂ to t₃. When the grid is in the close state OFF, the cathode electrons may be accelerated to bombard to the anode and form the tube current. The tube current (mA) may be a high level, which may be equivalent to the tube with the load, thereby reducing an actual output value of the high voltage generator. The high voltage generator may decrease the output voltage to be equal to the target tube voltage kV_2 of the target frame at the time point t₃, so that the actual tube voltage supplied by the high voltage generator to the X-ray tube may be equal to the target tube voltage kV_2 of the target frame. In the period of time from t₃ to t₄, the output voltage of the high voltage generator may be kept unchanged by the power device of the high voltage generator, so that the actual tube voltage kV may be constant, and the X-ray tube may work with the target tube voltage kV_2 of the target frame at the time point t₄ when the X-ray imaging system starts imaging to obtain the target frame.

In some embodiments of the present disclosure, the actual tube voltage may be decreased to the target tube voltage by making the tube discharge. Because the tube discharges relatively fast, the actual tube voltage may quickly decrease from the initial tube voltage to the target tube voltage, which may shorten the time to adjust the actual tube voltage.

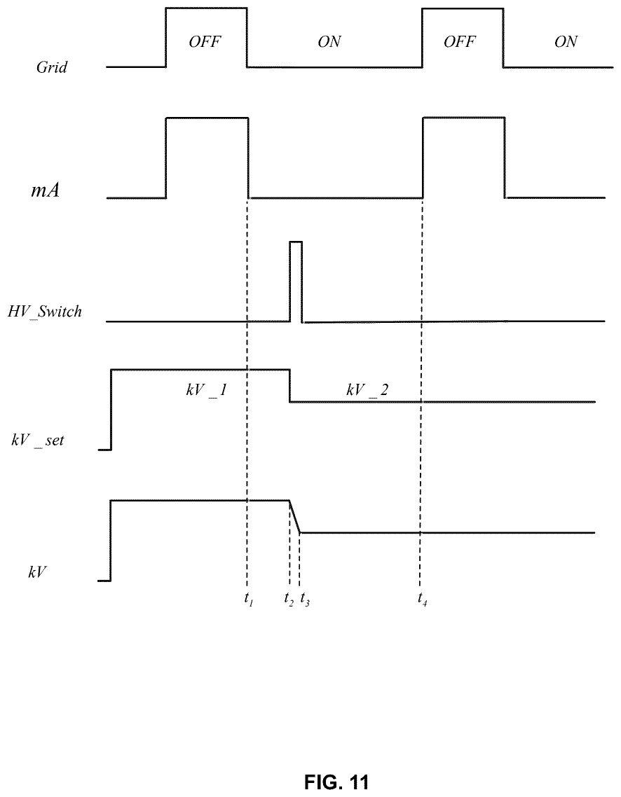

In some embodiments, when the discharge load includes the internal load of the high voltage generator. The processor 120 may decrease the actual tube voltage to the target tube voltage by controlling the internal load of the high voltage generator to discharge. Merely by way of example, as shown in FIG. 11, the high voltage generator may complete the loading of the initial tube voltage of the current frame at the time point t₁ and open the grid at this time by switching the voltage of the grid, thereby turning off the tube current (mA). In the period of time of t₁ to t₂, the high voltage generator may maintain the initial tube voltage kV_1 of the current frame by continuously outputting voltage through the power device. The processor 120 may determine that the target tube voltage of the target frame decreases to kV_2 at the time point t₂. The high voltage generator may turn off a high-voltage switch HV_Switch at the time point t₂. The output voltage may decrease to the target tube voltage kV_2 of the target frame at the time point t₃ by controlling the internal load of the high voltage generator to discharge, and the high-voltage switch HV_Switch may be disconnected. After the time point t₃, the loading output to the target frame of the target tube voltage kV_2 of the target frame may be continuously maintained through the power device of the high voltage generator, so that the X-ray tube may work with the target tube voltage kV_2 of the target frame at the time point when the X-ray imaging system starts imaging to obtain the target frame at the time point t₄.

In some embodiments of the present disclosure, the internal load of the high voltage generator may be controlled to discharge, which may not only decrease the actual tube voltage to the target tube voltage in the inter-frame period of time, but also may not generate additional radiation during the discharging of the internal load of the high voltage generator, thereby reducing the radiation measurement suffered by the patient.

In some embodiments, in the inter-frame period of time, the processor may, in response to determining that the target tube voltage is obtained, control a discharge load to discharge. For example, if the target tube voltage is obtained in the inter-frame period of time, the processor 120 may control the discharged load to discharge from the time point when the target tube voltage is obtained. Merely by way of example, as shown in FIG. 10 or FIG. 11, the processor 120 may obtain the target tube voltage at the time point t2 and control the discharge load to discharge from the time point t2. As another example, if the target tube voltage is obtained in advance, the processor may adjust the output of the high voltage generator immediately at the beginning of the inter-frame period of time.

In some embodiments of the present disclosure, the discharge load may be controlled to discharge from the time point when the target tube voltage is obtained, and the discharge load may have a relatively long time to discharge, so that the actual tube voltage may be equal to or close to the target tube voltage before the time point when the X-ray imaging system starts imaging to obtain the target frame, thereby shortening the imaging time.

In some embodiments, the actual tube voltage may be decreased to the target tube voltage before a time point when the X-ray imaging system starts imaging to obtain the target frame. Merely by way of example, as shown in FIG. 10 or FIG. 11, the processor 120 may decrease the actual tube voltage KV to the target tube voltage kV_2 before the time point t4 when the X-ray imaging system starts imaging to obtain the target frame. In some embodiments, due to limitation of a discharge power of the discharge load, at the time point t4, the actual tube voltage may be adjusted to be close to the target tube voltage kV_2 of the target frame, and at the time point when the X-ray imaging system starts imaging to obtain the target frame, the actual tube voltage may be decreased to the target tube voltage by continuing to control the discharge load to discharge.

In some embodiments of the present disclosure, the actual tube voltage may be decreased to the target tube voltage before the time point when the X-ray imaging system starts imaging to obtain the target frame, so that the X-ray tube may work with the target tube voltage of the target frame at the time point when the X-ray imaging system starts imaging to obtain the target frame, thereby shortening the imaging time and reducing the radiation measurement suffered by the patient.

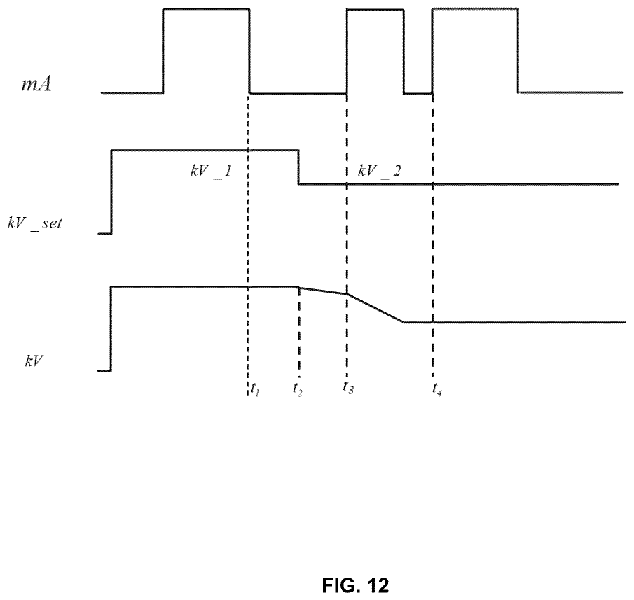

In some embodiments, a process that the processor 120 controls the at least one discharge load in the X-ray imaging system to discharge may include controlling the at least one discharge load to discharge by stages. That is, in the inter-frame period of time, the processor may, in response to determining that the target tube voltage is obtained, obtain a natural discharge state by turning off the high voltage generator and switch the natural discharge state to a load discharge state. For example, if the target tube voltage is obtained in the inter-frame period of time, the controlling the at least one discharge load to discharge by stages may include obtaining a natural discharge state by turning off the high voltage generator at the time point when the target tube voltage is obtained and decreasing the actual tube voltage to the target tube voltage by switching the natural discharge state to a load discharge state before the time point when the X-ray imaging system starts imaging to obtain the target frame. Merely by way of example, as described in FIG. 12, the high voltage generator may complete loading of the initial tube voltage of the current frame at the time point t₁ and open the grid at this time by switching the voltage of the grid, thereby turning off the tube current (mA). In the period of time from t₁ to t₂, the high voltage generator may maintain the initial tube voltage kV_1 of the current frame by continuously outputting voltage through the power device. The processor 120 may determine that the target tube voltage of the target frame decreases to kV_2 at the time point t₂ and may obtain the natural discharge state by turning off the power device of the high voltage generator at the time point t₂. At the time point t₃, the processor 120 may decrease the actual tube voltage to the target tube voltage by switching the natural discharge state to the load discharge state before the time point t₄ when the X-ray imaging system starts imaging to obtain the target frame.

In some embodiments of the present disclosure, the natural discharge state may be obtained by turning off the high voltage generator and the natural discharge state may be switched to the load discharge state, so that the actual output voltage of the high voltage generator may be accelerated to decrease to the target tube voltage quickly, thereby shortening the adjustment time.

In some embodiments, the processor 120 may predict a time point of switching the natural discharge state to the load discharge state based on a load of a circuit (e.g., a magnitude of resistance of a resistor in the circuit) and the discharge load.

In some embodiments, the storage device may pre-store different loads of circuits and a correspondence between the discharge load and the predicted time point of switching the natural discharge state to the load discharge state. The processor 120 may generate the predicted time point of switching the natural discharge state to the load discharge by accessing the storage device based on the determined load of the circuit and the discharge load through the correspondence.

In some embodiments of the present disclosure, the time point of switching the natural discharge state to the load discharge may be predicted, so that not only it may be realized that the actual tube voltage is decreased to the target tube voltage before the time point when the X-ray imaging system starts imaging to obtain the target frame, but also the natural discharge of the circuit may be fully utilized, thereby reducing the additional radiation generated by the load discharge and reducing the radiation damage suffered by the patient.

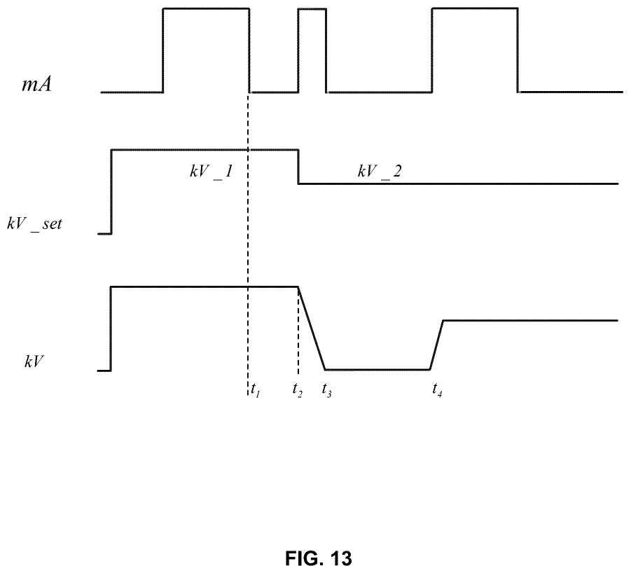

In some embodiments, the processor 120 may decrease the actual tube voltage to be less than the target tube voltage before the time point when the X-ray imaging system starts imaging to obtain the target frame. Merely by way of example, as shown in FIG. 13, the high voltage generator may complete the loading of the initial tube voltage of the current frame at the time point t₁ and open the grid at this time by switching the voltage of the grid, thereby turning off the tube current (mA). In the period of time of t₁ to t₂, the high voltage generator may maintain the initial tube voltage kV_1 of the current frame by continuously outputting voltage through the power device. The processor 120 may determine that the target tube voltage of the target frame decreases to kV_2 at the time point t₂. The actual output voltage of the high voltage generator may be decrease by closing the grid briefly in the period of time of t₂ to t₃. At the time point t₃, the output voltage of the high voltage generator may be decreased to be less than the target tube voltage kV_2 of the target frame (e.g., less than the target tube voltage kV_2 of the target frame but close to the target tube voltage kV_2 of the target frame). The loading of the target frame may start at the time point t₄, and in a brief period of time after the time point t₄, the actual tube voltage kV may be increased to the target tube voltage kV_2 of the target frame by increasing the output voltage of the high voltage generator to the target tube voltage kV_2.

In some embodiments, the processor 120 may decrease the actual tube voltage to a minimum magnitude of voltage. The minimum magnitude of voltage may be 0 or other set value. For example, the processor 120 may decrease the actual tube voltage to 0 by controlling the grid to open and make the tube to fully discharge.

In some embodiments, the processor 120 may increase the actual tube voltage to the target tube voltage by adjusting the output of the high voltage generator at the time point when the X-ray imaging system starts imaging to obtain the target frame. Merely by way of example, as shown in FIG. 12, the loading of the target frame may start at the time point t4, and in a short period of time after the time point t4, the processor 120 may increase the actual tube voltage kV to the target tube voltage kV_2 of the target frame by controlling the output voltage of the high voltage generator to increase to the target tube voltage kV_2.

It should be understood that when the output power of the high voltage generator is significantly greater than the discharge power of the discharge load, the actual tube voltage may be decreased to be less than the target tube voltage or even decreased to 0 before the time point when the X-ray imaging system starts imaging to obtain the target frame. At the time point when the X-ray imaging system starts imaging to obtain the target frame, the actual tube voltage may be increased to the target tube voltage by adjusting the output of the high voltage generator and the adjustment of the actual tube voltage may be more controllable, so that the finally adjusted actual tube voltage may be closer to the target tube voltage.

In some embodiments, the processor 120 may increase the actual tube voltage to the target tube voltage by adjusting the output of the high voltage generator at the time point when the X-ray imaging system starts imaging to obtain the target frame. It should be understood that the increasing to the target tube voltage at the time point when the X-ray imaging system starts imaging to obtain the target frame includes that the actual tube voltage is increased to the target tube voltage just at time point when the X-ray imaging system starts imaging to obtain the target frame, and the actual tube voltage has been increased to the target tube voltage before the time point when the X-ray imaging system starts imaging to obtain the target frame. For example, the processor 120 may increase the actual tube voltage to the target tube voltage before the time point when the X-ray imaging system starts imaging to obtain the target frame by increasing the output voltage of the high voltage generator in the period of time of t3 to t4.

In some embodiments of the present disclosure, the actual tube voltage may be increased to the target tube voltage by adjusting the high voltage generator before the time point when the X-ray imaging system starts imaging to obtain the target frame, so that the X-ray tube may work with the target tube voltage of the target frame at the time point when the X-ray imaging system starts imaging to obtain the target frame, thereby shortening the imaging time and reducing the radiation measurement suffered by the patient.

In some embodiments of the present disclosure, the actual tube voltage may be changed to the target tube voltage by adjusting the working state of the device of the X-ray imaging system in the inter-frame period of time based on the comparison result between the target tube voltage and the initial tube voltage, thereby shortening the imaging time, reducing the radiation damage suffered by the patient, and improving the imaging quality.

It should be noted that the description of process 600 is merely provided for the purpose of illustration, and not intended to limit the scope of application of the present disclosure. For those skilled in the art, various modifications and changes may be made to the process 600 under the guidance of the present disclosure. However, these modifications and changes do not depart from the scope of the present disclosure.

One or more embodiments of the present disclosure provide an X-ray imaging system. The X-ray imaging system may include a high voltage generator, an X-ray tube, and a processor. An output end of the high voltage generator may be connected to an input end of the X-ray tube. The high voltage generator may be configured to supply power to the X-ray tube, and the processor 120 may be configured to perform the process of controlling the voltage of the X-ray imaging as described in any one of the above embodiments.

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements and amendments to the present disclosure. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various parts of this specification are not necessarily all referring to the same embodiment. In addition, some features, structures, or features in the present disclosure of one or more embodiments may be appropriately combined.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that the present disclosure object requires more features than the features mentioned in the claims. Rather, claimed subject matter may lie in less than all features of a single foregoing disclosed embodiment.

In some embodiments, the numbers expressing quantities or properties used to describe and claim certain embodiments of the present disclosure are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

1. A method for controlling a voltage of an X-ray imaging system, implemented by a processor, comprising:
obtaining an initial tube voltage and a target tube voltage; and
adjusting an actual tube voltage of the X-ray imaging system by controlling a working state of each of one or more devices of the X-ray imaging system based on the initial tube voltage and the target tube voltage in an inter-frame period of time.

2. The method of claim 1, wherein the method further comprises: making an output of a high voltage generator in a controllable state in the inter-frame period of time.

3. The method of claim 1, wherein the adjusting the actual tube voltage of the X-ray imaging system by controlling the working state of the each of the one or more devices of the X-ray imaging system based on the initial tube voltage and the target tube voltage includes:
in response to the target tube voltage being equal to the initial tube voltage, maintaining the actual tube voltage at the initial tube voltage in the inter-frame period of time by adjusting an output of a high voltage generator.

4. The method of claim 1, wherein the adjusting the actual tube voltage of the X-ray imaging system by controlling the working state of the each of the one or more devices of the X-ray imaging system based on the initial tube voltage and the target tube voltage includes:
in response to the target tube voltage being not equal to the initial tube voltage, changing the actual tube voltage from the initial tube voltage to the target tube voltage in at least a portion of the inter-frame period of time by adjusting a working state of at least one device of the X-ray imaging system in the inter-frame period of time.

5. The method of claim 4, wherein the adjusting the working state of at least one device of the X-ray imaging system in the inter-frame period of time includes:
in response to determining that the target tube voltage is obtained, adjusting an output of a high voltage generator.

6. The method of claim 4, wherein the adjusting the working state of at least one device of the X-ray imaging system in the inter-frame period of time includes:
in response to determining that the target tube voltage is obtained, controlling a discharge load to discharge.

7. The method of claim 4, wherein the adjusting the working state of at least one device of the X-ray imaging system in the inter-frame period of time includes:
in response to determining that the target tube voltage is obtained, obtaining a natural discharge state by turning off a high voltage generator and switching the natural discharge state to a load discharge state.

8. The method of claim 4, wherein the adjusting the actual tube voltage of the X-ray imaging system by controlling the working state of the each of the one or more devices of the X-ray imaging system based on the initial tube voltage and the target tube voltage includes:
in response to the target tube voltage is greater than the initial tube voltage, increasing the actual tube voltage to the target tube voltage in the inter-frame period of time by adjusting an output of a high voltage generator.

9. The method of claim 8, wherein the adjusting the output of the high voltage generator includes:
in response to determining that the target tube voltage is obtained, adjusting the output of the high voltage generator.

10. The method of claim 8, wherein an adjustment period of time for adjusting the output of the high voltage generator is a period of time from a first time point when the target tube voltage is obtained to a second time point when the X-ray imaging system starts imaging to obtain a target frame, and the adjustment period of time is determined by:
determining an estimated adjustment period of time based on a hardware configuration and a difference between the initial tube voltage and the target tube voltage; and
determining a start time of the adjustment period of time based on the estimated adjustment period of time.

11. (canceled)

12. The method of claim 4, wherein the adjusting the actual tube voltage of the X-ray imaging system by controlling the working state of the each of the one or more devices of the X-ray imaging system based on the initial tube voltage and the target tube voltage includes:
in response to the target tube voltage is less than the initial tube voltage, decreasing the actual tube voltage to the target tube voltage in the at least the portion of the inter-frame period of time by controlling at least one discharge load in the X-ray imaging system to discharge in the inter-frame period of time.

13. The method of claim 12, wherein the discharge load includes a tube, and the decreasing the actual tube voltage to the target tube voltage in the at least the portion of the inter-frame period of time by controlling the at least one discharge load in the X-ray imaging system to discharge in the inter-frame period of time includes:
decreasing the actual tube voltage to the target tube voltage by making the tube to discharge by closing a grid of the tube.

14. The method of claim 12, wherein the discharge load includes an internal load of a high voltage generator, and the decreasing the actual tube voltage to the target tube voltage in the at least the portion of the inter-frame period of time by controlling the at least one discharge load in the X-ray imaging system to discharge in the inter-frame period of time includes:
decreasing the actual tube voltage to the target tube voltage by controlling the internal load of the high voltage generator to discharge.

15. The method of claim 12, wherein the controlling the at least one discharge load in the X-ray imaging system to discharge includes:
in response to determining that the target tube voltage is obtained, controlling the at least one discharge load to discharge.

16. The method of claim 12, wherein the controlling the at least one discharge load in the X-ray imaging system to discharge includes controlling the at least one discharge load to discharge by stages, and the controlling the at least one discharge load to discharge by stages includes:
in response to determining that the target tube voltage is obtained, obtaining a natural discharge state by turning off a high voltage generator; and
decreasing the actual tube voltage to the target tube voltage by switching the natural discharge state to a load discharge state before a time point when the X-ray imaging system starts imaging to obtain a target frame.

17. The method of claim 12, wherein the decreasing the actual tube voltage to the target tube voltage in the at least the portion of the inter-frame period of time by controlling the at least one discharge load in the X-ray imaging system to discharge in the inter-frame period of time includes:
decreasing the actual tube voltage to the target tube voltage before a time point when the X-ray imaging system starts imaging to obtain a target frame;-or
decreasing the actual tube voltage to be less than the target tube voltage before a time point when the X-ray imaging system starts imaging to obtain a target frame.

18. (canceled)

19. The method of claim 17, wherein the decreasing the actual tube voltage to be less than the target tube voltage includes:
decreasing the actual tube voltage to a minimum magnitude of voltage.

20. The method of claim 17, further comprising:
increasing the actual tube voltage to the target tube voltage by adjusting an output of a high voltage generator at the time point when the X-ray imaging system starts imaging to obtain a target frame; or
increasing the actual tube voltage to the target tube voltage by adjusting an output of a high voltage generator before a time point when the X-ray imaging system starts imaging to obtain a target frame.

21-22. (canceled)

23. An X-ray imaging system, comprising a high voltage generator, an X-ray tube, and a processor, wherein an output end of the high voltage generator is connected to an input end of the X-ray tube, the high voltage generator is configured to supply power to the X-ray tube, and the processor is configured to perform the method for controlling the voltage of the X-ray imaging system according to the method of claim 1.

24. An X-ray imaging device, wherein the device is configured to perform the method for controlling the voltage of the X-ray imaging system according to the method of claim 1.

25. (canceled)
